(19) United States
(12) Patent Application Publication
(10) Pub. No.: US 2013/0142922 A1
(43) Pub. Date: Jun. 6, 2013

(54) Pita bun

(71) Applicants: Anthony Scott Daniels, Ann Arbor, MI (US); Susanne Marie Daniels, Ann Arbor, MI (US)

(72) Inventors: Anthony Scott Daniels, Ann Arbor, MI (US); Susanne Marie Daniels, Ann Arbor, MI (US)

(21) Appl. No.: 13/374,736

(22) Filed: Jan. 11, 2012

Related U.S. Application Data
(60) Provisional application No. 61/629,907, filed on Dec. 1, 2011.

(51) Int. Cl. A21D 13/00

(52) U.S. Cl. 426/138

(57) ABSTRACT

A hotdog or bratwurst bun having a three section open faced design is described. The middle face holds the hotdog or bratwurst and the two side faces fold upward and around the hotdog and toppings. The three faces are a connected, continuous piece of bread with the creases between the sections being flattened portions of the bread.

### REFERENCE LIST

| | | | | | |
|---|---|---|---|---|---|
| Ref# | U.S. Patent # | Date | Inventor | Title | Type |

U.S. PATENT DOCUMENTS REFERENCES

| | | | | | |
|---|---|---|---|---|---|
| R1 | D0584478 | Jan. 13, 2009 | Murray | Combination Hamburger and Hot | Combination bun |
| | | | | Dog Bread Bun | design |
| R2 | D0579626 | Nov. 40, 2008 | Schulman | Hot Dog Bun | Bread boat design |
| R3 | D0498987 | Nov. 30, 2004 | Vodhanel | Apparatus for Making a Cavity in | Male/female mold |
| | | | | Bun | |
| R4 | D0496519 | Sep. 28, 2004 | Weld | Bun for Hotdogs | Halloween Monster |
| | | | | | Bun design |
| R5 | D0486291 | Feb. 10, 2004 | Weld | Bun for Hamburgers or the Like | Halloween Monster |
| | | | | | Bun design |
| R6 | D0485961 | Feb. 3, 2004 | Weld | Bun for Hotdogs or the Like | Halloween Monster |
| | | | | | Bun design |
| R7 | D0450420 | Nov. 20, 2001 | Brost | Bun | Bread boat design |
| R8 | D0427747 | Jul. 11, 2000 | Bentley | Bread Bun | Hollowed cylinder |
| | | | | | design |
| R9 | D0377297 | Jan. 14, 1997 | Thompson | Bagel, Roll, and Bun Holder Device | Bread slicer |
| R10 | D0377257 | Jan. 14, 1997 | Calvin | Vertical, Free Standing Hot Dog | Hollowed cylinder |
| | | | | Bun | design |
| R11 | D0317522 | Jun. 18, 1991 | Hicks | Hamburger Bun or Similar Article | Animal shaped |
| | | | | | design |
| R12 | D0314853 | Feb. 26, 1991 | Garrett | Hot Dog Bun For Two Hot Dogs | Twin cavity design |
| R13 | D0295455 | May 03, 1988 | Han | Burger Bun or Similar Article | Raised back design |
| R14 | D0264390 | May 18, 1982 | Long | Hamburger Bun | Animal shaped |
| R15 | D0261820 | Nov. 17, 1981 | Yamanaka | Combined Hot Dog and Bun | Corn Dog design |
| R16 | 05946998 | Sep. 07, 1999 | Thompson | Bagel, Roll, and Bun Holder Device | Bread slicer |
| R17 | 05897900 | Apr. 27, 1999 | Groulx | Edible Bun Having a | Bread boat design |
| | | | | Compartmented Central Access | |
| R18 | 05690019 | Nov. 25, 1997 | Barker | Bread Bun Mold | Male/Female mold |
| R19 | 05638734 | Jun. 17, 1997 | Fish | Bagel and Bun Slicer Apparatus | Bread slicer |
| R20 | 05528981 | Jun. 25, 1996 | Pettit | Sandwich Bun Mold | Bread mold |
| R21 | 05485772 | Jan. 23, 1996 | Bastasch | Bun Slicing Machine | Bread slicer |
| R22 | 04656935 | Mar. 14, 1987 | Kukura | Apparatus for Making Ovular | Bread mold |
| | | | | Shaped Edible Bun | |
| R23 | 04348949 | Sep. 14, 1982 | Selleck | Non-Saturable Bun | Bread mold |
| R24 | 04190229 | Feb. 26, 1980 | Bradshaw | Hot Dog Bun Pan | Bread boat design |
| R25 | 04047477 | Sep. 13, 1977 | Berke | Hot Dog Bun Baking Pan | Bread boat design |
| R26 | 03950563 | Mar. 13, 1976 | Wheaton | Method for Making a Bun | Bread boat design |
| R27 | 03943840 | Mar. 16, 1976 | Bolte | Pocket Bun Baking Device | Bread mold |

U.S. PROVISIONAL PATENT APPLICATION

| | | | | |
|---|---|---|---|---|
| R28 | Provisional | Dec. 1, 2011 | Daniels and | Pita Bun |
| | Patent | | Daniels | |
| | Application | | | |

OTHER PUBLICATIONS

| | |
|---|---|
| R29 | Daniels, Anthony. “PITA BUN” Anthony Scott Daniels Invention Log 4. |
| | Date Sep. 30, 2009. - not published |

### BACKGROUND OF INVENTION

1. Field of Invention

The field of invention relates generally to hot dog or bratwurst buns.

2. Description of Prior Art

The hot dog or bratwurst bun has been a staple of summer barbeques, county fairs, and sporting events for many decades. The standard bun design is a small loaf of light density bread with a single partial slice down the middle. [R1, R2, R4, R5, R6] The slice doesn't go all the way through the bread creating a hinge on one side. In addition to the standard bun design, bread boat designs [R7, R17, R24, R25, R26] and hollowed cylinder designs [R10, R15] have been attempted. The purpose of the PITA BUN [R28, R29] design is to improve upon the shortcomings of the traditional hotdog bun.

### BRIEF SUMMARY OF THE INVENTION

A hotdog or bratwurst bun having a three section open faced design is described. The middle face holds the hotdog or bratwurst and the two sides' faces fold upward and around the hotdog and toppings. The three faces are a connected, continuous piece of bread with the creases between the sections being flattened portions of the bread.

### BRIEF DESCRIPTION OF THE DRAWINGS

The following is a brief description of the drawings enclosed in this document. For a complete understanding of the content of these drawings and the objects of the invention, please refer to the detailed description of the invention in this document.

The accompanying drawings are:

FIG. 1—Cross sectional view of the PITA BUN with hot dog in unfolded configuration.

FIG. 2—Cross sectional view of the PITA BUN with hot dog in folded configuration.

FIG. 3—Front view of the PITA BUN with hot dog in folded configuration.

FIG. 4—Top isometric view of the PITA BUN with the hot dog in folded configuration.

FIG. 5—Bottom isometric view of the PITA BUN with the hot dog in folded configuration.

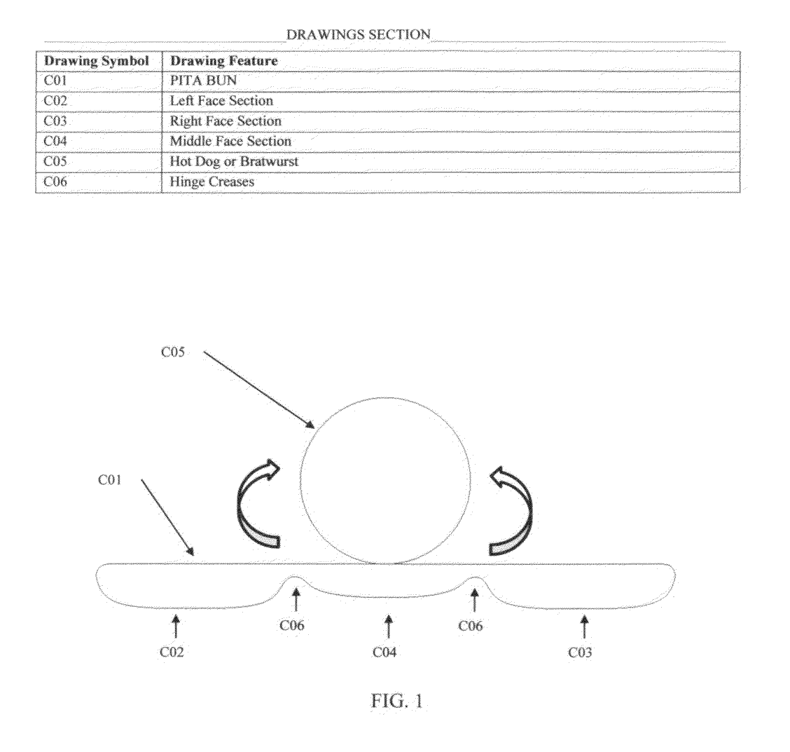

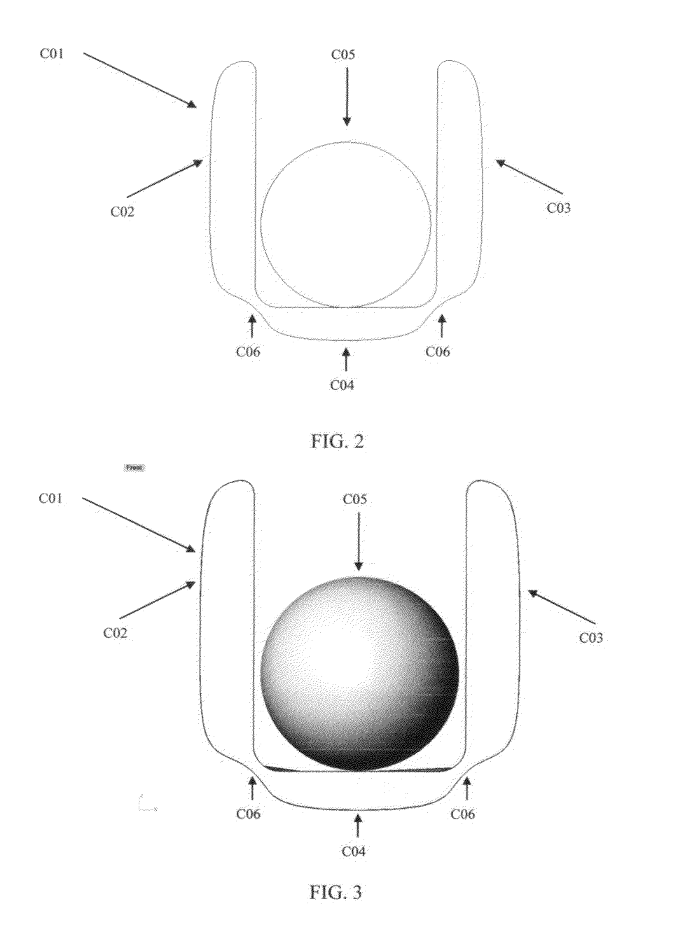

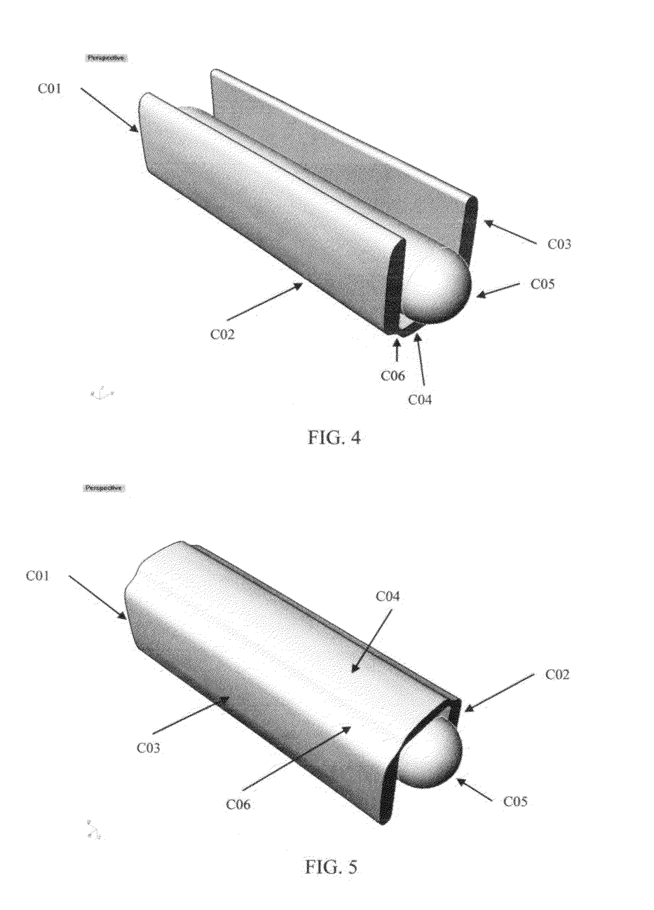

### DETAILED DESCRIPTION OF THE INVENTION

The hot dog or bratwurst bun has been a staple of summer barbeques, county fairs, and sporting events for many decades. The standard bun design is a small loaf of light density bread with a single partial slice down the middle. The slice doesn't go all the way through the bread creating a hinge on one side. This hinge is a strong weakness of the traditional hot dog bun design. Hot dog buns can often be too small for what they are holding, especially if there are a lot of condiments. A large amount of time is spent picking up what falls out of them. In addition, the hinge is usually not strong enough to stay together and food falls out of the bottom, or the whole assembly falls apart. The PITA BUN is a proposed hot dog or bratwurst bun design that addresses and improves upon those weaknesses.

The PITA BUN [C01] is a hotdog or bratwurst bun having a three section open faced design is described. The middle face [C04] holds the hotdog or bratwurst and the two side faces [C02, C03] fold upward and around the hotdog and toppings. The three faces are a connected, continuous piece of bread with the creases [C06] between the sections being flattened portions of the bread. Unlike standard hot dog buns, this bun is baked open faced and there are no slices or cuts. The creases can be formed either by molding in the baking tray, or by flat compression rollers that compress the crease lines. Because the hinges contain a full thickness (or close to it) of bread that is compressed, they are much stronger than the thin sliced hinge of the traditional hot dog bun. This produces a bun that is much more resistant to tearing or falling apart. In addition, because the PITA BUN allows for a “U” shape around the hot dog [C05] rather than the “V” shape of the traditional hot dog bun, this should provide better containment of the hot dog and condiments.

The PITA BUN is different from a standard pita because it is baked from the same light density bread that a traditional hot dog bun is made from. The PITA BUN tastes like a traditional hot dog bun. Standard pitas are typically made of high density bread and often crack when folded, unlike the hinged PITA BUN. In addition, there is no internal pocket in the PITA BUN like that present in a standard pita.

Now that a detailed description has been addressed, the claimed invention is:

1. A hotdog or bratwurst bun having a three section open faced design. The middle face holds the hotdog or bratwurst and the two side faces fold upward and around the hotdog and toppings.

2. The three faces are a connected, continuous piece of bread with the creases between the sections being flattened portions of the bread.
